(19) United States
(12) Patent Application Publication
(10) Pub. No.: US 2021/0277260 A1
(43) Pub. Date: Sep. 9, 2021

(54) SURFACE COATING COMPOSITION WITH LONG DURABILITY

(71) Applicant: EVONIK OPERATIONS GMBH, Essen (DE)

(72) Inventors: Jianmin XU, Shanghai (CN); Lengfeng ZHENG, Shanghai (CN); Oliver SCHALLER, Seeheim-Jugenheim (DE)

(73) Assignee: EVONIK OPERATIONS GMBH, Essen (DE)

(21) Appl. No.: 17/257,445

(22) PCT Filed: Jul. 1, 2019
(86) PCT No.: PCT/CN2019/094142

§ 371 Date: Dec. 31, 2020

(30) Foreign Application Priority Data
Jul. 2, 2018 (CN) PCT/CN2018/094135

(51) Int. Cl. C09D 7/62; C09D 7/63; C09D 7/65; C09D 17/00; C09K 3/18; C08K 3/36; C08K 9/06; C08K 5/5419; C08K 5/544; C08G 77/08; C08G 77/16; C08G 77/18; C08G 77/24; C08G 77/26; C08G 77/00; C08K 5/01; C08K 5/02

(52) U.S. Cl. CPC C09D 7/62; C08K 2201/011; C09D 7/65; C09D 17/002; C09K 3/18; C08K 3/36; C08K 9/06; C08K 5/5419; C08K 5/544; C08G 77/08; C08G 77/16; C08G 77/18; C08G 77/24; C08G 77/26; C08G 77/80; C08K 5/01; C08K 5/02; C08K 2201/005; C09D 7/63

(57) ABSTRACT

The present invention relates to a coating composition comprising (A) hydrophobically modified fumed silica particles, (B) one or more compounds of hydrolyzed organosilanes, and (C) a solvent or mixture of solvents. The coating composition may be used to treat substrates such as glass surface to make the substrate surfaces possess valuable properties such as water repellency, dirt repellency and self-cleaning with water.

The present invention relates to a composition, preferably a coating composition, to treat substrates such as glass surface to make the substrate surfaces possess valuable properties such as water repellency, dirt repellency and self-cleaning with water.

Hydrophobic modification of substrate surfaces is very useful and popular in many household, industrial and institutional applications. Examples for substrates to be treated are shower room, furniture, ceramics, facades and fences in garden area, rear view mirrors, stainless steel or aluminum car rims, car body, and even fabric treatment like tents, clothing, canvas car roofs, etc. Hydrophobic modification of substrate surfaces results for example in quick drying, dirt repellency, corrosion inhibition, insect protection, etc. Corresponding technologies include but are not limited to treatment with cationic surfactants, silicone quats, functional silanes, and nano-dispersions.

CN101314698 discloses an abrasion resistant coating composition comprising a silicone resin, hydrophobic silica microparticles, a curing catalyst and a solvent. As silicone resin a pre-polymerized polysiloxane, obtained by hydrolysis and condensation of specific organosilanes, is used. After application of the coating composition to a surface of a substrate, final curing and crosslinking of the polysiloxane is initiated by the curing catalyst, which results in a crosslinked polymeric silicone film on the surface of the substrate. The polymeric film increases abrasion and crack resistance. There is no disclosure regarding water repellency of the surface. The production process of the coating compositions disclosed in CN101314698 is complex due to the pre-polymerization step. The coating composition is difficult to handle due to the use of a curing catalyst. It has to be avoided that catalysts initiates the final curing and crosslinking process too early. The disclosed coating composition is not storage stable.

WO 2016032738 A1 discloses a coating composition comprising fluoroalkylsilicone compounds with high water repellency.

EP 1960481 B1 and WO 2007068545 disclose a coating composition comprising a) at least one hydrolyzable fluoroalkylsilane b) HCl, c) water, d) isopropanol, and e) at least one solvent and/or diluent. Such coating composition based on hydrolyzed organosilanes are durable for several months. However, the water-repellence is not satisfactory. The self-cleaning at water rinse is limited and they show enhanced adhesion for non-polar dust. In addition, the application method on substrate surface is not so easy.

WO2007051747 discloses a process for producing a process composition to be used in treatment compositions intended for applying a transparent, detachable and renewable protective coating on a receptive surface which provides dirt- and water-repellency comprising: (a) providing a pre-dispersion of silica particles comprising hydrophobically modified fumed silica particles by stirring said silica particles into a solution comprising a silane compound and a volatile solvent or solvent mixture, and (b) mixing with a disperser said pre-dispersion to provide a process composition while reducing said silica particles to a median particle size in the range between 100 and 4000 nm. The solution may further comprises at least one durability agent selected from alkoxysilanes such as fluoroalkylsilanes.

US 20060110541 A1 discloses a treatment composition for forming a detachable and renewable protective coating on a receptive surface comprising: (i) 0.05 to 5.0 percent by weight of a plurality of hydrophobically modified fumed silica particles having a median particle size of between 100 and 4,000 nanometers; (ii) 99.95 to 5 percent by weight of a volatile solvent; (iii) optionally, 0.001 to 5 percent by weight of a suspending agent; (iv) optionally, 0.001 to 5 percent by weight of a functional adjunct; and (v) optionally, in balance to 100 percent by weight if present, a propellant; wherein said treatment composition when applied to said receptive surface deposits said protective coating on said receptive surface, wherein said protective coating provides dirt- and water-repellency to said receptive surface, and wherein said coating is substantially transparent and results in a change of less than 3.0 Delta E units to said receptive surface measured before and after deposition of said coating.

However, the durability of such treatment compositions comprising silica particles, volatile solvent and optionally alkoxysilanes such as fluoroalkylsilanes needs to be further improved.

The objective of the present invention is to overcome as least part of the defects of the prior art. In particular it is an objective of the present invention to provide a new composition with improved properties as well as to provide process for preparation of said composition and its use as surface treating agent.

A special object of the present invention is to provide a composition that can be used to modify surfaces of different substrates to generate long lasting super-water repellent and self-cleaning properties.

A further object of the present invention was to provide a composition with an adjustable degree of transparency if applied to a surface of a substrate. It should for example be possible that the applied coating is transparent.

Further, not explicitly mentioned, objects become apparent from the overall context of the subsequent description, examples and claims.

The invention relates to a composition, preferably a coating composition, comprising hydrophobic sub-micron to micron particles of fumed silica, hydrolyzation products of organosilanes and a solvent. Preferably the silica particles are finally dispersed in said composition. Surfaces treated with the composition of the invention have long lasting super-water repellent and self-cleaning properties. Water is repelled from the treated surface with high contact angles e.g. above 140° or higher (nearly a ball shaped droplet). Surfaces become dirt repelling and self-cleaning when subjected to rain or rinsing with plain water.

Without being bond to any theory, the inventors believe that the water repellency and self-cleaning effect is caused by the hydrophobically treated, sub-micron fumed silica particles. The hydrolyzed organosilane compounds comprised in the composition of the invention act as coupling agent between the hydrophobically treated fumed silica particles and the surface and thus ensure long durability (adhesion) of the silica particles on the substrate surface. In contrast to concepts of the prior art, e.g. CN101314698, where silica particles are embedded in a polymeric film, that was formed by polymerization of the hydrolyzed organosilanes compounds, and thus only parts of the particles are at the surface of the film, the concept of the present invention allows to make use of the full super-hydrophobicity potential of the silica particles. The differences of both concepts can be observed on the coated substrates. The binding of silica with hydrolyzed silane is weak. Thus, the coating of the present invention can usually be easily removed by gentle touch of finger from the coated substrates and has clearly different properties from polymer film coatings.

Further advantages of the present invention become apparent from the context of the subsequent description, examples and claims.

Terms such as “comprise(s)” and the like as used herein are open terms meaning ‘including at least’ unless otherwise specifically noted.

All references, tests, standards, documents, publications, etc. mentioned herein are incorporated herein by reference. Where a numerical limit or range is stated, the endpoints are included. Also, all values and subranges within a numerical limit or range are specifically included as if explicitly written out.

The description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

The present invention provides a composition, in particular a coating composition, comprising
(A) Hydrophobically modified fumed silica particles with a median particle size of from 100 to 100,000 nm,
(B) One or more organosilanol compounds selected from the group consisting of
   compounds according to Formula (I), wherein Formula (I) is as follows:

X—R—Si(OH)ₘY¹ₙY²ₒ Formula (I)
and wherein
X represents a non-hydrolyzable organic residue or functional group,
R represents a spacer, which can be either an aryl or alkyl chain, preferably (CH₂)_{q} with q=1, 2 or 3,
Y¹ and Y² may be identical or different and each represents a hydrolysable or non-hydrolyzable moiety,
m=1, 2 or 3, preferably m=2 or 3, most preferred 3,
n, o each may be 0 or 1, but are selected such that m+n+o=3, and
dimeric compounds of Formula (I), trimeric compounds of Formula (I), and oligomeric compounds formed by self-condensation reaction of up to 8 preferably up to 7, 6, 5 or 4 molecules according to Formula (I), provided that the compound has at least one or two free —OH groups,
and
(C) A solvent or mixture of solvents.

X preferably represents a linear, branched or non-branched aliphatic alkyl residue with 1 to 12, more preferred 1 to 6 carbon atoms, optionally substituted with fluorine or chlorine atoms, preferably with fluorine atoms, or a functional group selected from the group consisting of amino, epoxy, vinyl, methacrylate, sulfur groups.

Most preferred, X represents a non-hydrolyzable linear, branched or non-branched aliphatic alkyl residue with 1 to 12 substituted with fluorine atoms.

Y¹ and Y² are preferably selected from the group consisting linear, branched or non-branched, alkyl groups with 1 to 12, preferably with 1 to 6 carbon atoms, more preferred methyl, ethyl or propyl, most preferred methyl, or cyclic aliphatic alkyl groups with 1 to 12, preferably 1 to 6 carbon atoms, and aryl groups with 6 to 12 carbon atoms, halogen, preferably chlorine, alkoxy groups with 1 to 12, preferably 1 to 6 carbon atoms, more preferred methoxy, ethoxy, isopropoxy and n-propoxy and acyl groups with 1 to 12, preferably 1 to 6 carbon atoms, more preferred formyl, acetyl.

Component (B) comprises organosilanols. An organosilanol is a silanol that contains one or more organic residue. A silanol is a functional group in silicon chemistry with the connectivity Si—O—H.

The oligomeric compounds may include both cyclic and linear oligosiloxanes. Linear oligolsilaxanes are preferred.

The compounds according to Formula (I) are preferably obtained by hydrolyzation of an organosilane according to Formula (II), more preferred by hydrolyzation with water and a catalyst and most preferred with an acid as catalyst, wherein Formula (II) is as follows:

X—R—SiY¹Y²Y³ Formula (II)

and wherein X, R, are defined as above and Y¹, Y² and Y³ may be identical or different and each represents a hydrolysable or non-hydrolyzable moiety, with the provision that at least one of Y¹, Y² and Y³ is hydrolyzable.

In Formula (II), Y¹, Y² and Y³ are preferably selected from the group consisting linear, branched or non-branched, alkyl groups with 1 to 12, preferably with 1 to 6 carbon atoms, more preferred methyl, ethyl or propyl, most preferred methyl, or cyclic aliphatic alkyl groups with 1 to 12, preferably 1 to 6 carbon atoms, and aryl groups with 6 to 12 carbon atoms, halogen, preferably chlorine, alkoxy groups with 1 to 12, preferably 1 to 6 carbon atoms, more preferred methoxy, ethoxy, isopropoxy and n-propoxy and acyl groups with 1 to 12, preferably 1 to 6 carbon atoms, more preferred formyl, acetyl, with the provision that at least one of Y¹, Y² and Y³ is hydrolyzable, i.e. is selected from the group consisting of halogen, preferably chlorine, alkoxy groups with 1 to 12, preferably 1 to 6 carbon atoms, more preferred methoxy, ethoxy, isopropoxy and n-propoxy and acyl groups with 1 to 12, preferably 1 to 6 carbon atoms, more preferred formyl, acetyl.

“Non hydrolyzable” as used herein means that the bond(s) between the residue or functional group and the remaining organosilane is not cleaved when getting in contact with the catalyst, preferably an acid, and water. Conversely “hydrolysable” means that the residue or functional group is separated from the organosilane or substituted with a hydroxy group during the reaction with the catalyst, preferably an acid, and water.

The hydrolyzed organosilane comprises one or more hydroxy group(s) instead of the original residue or functional groups Y¹, Y² and/or Y³, i.e. compounds according to Formula (I) are formed. It is, however, possible that part of the compounds according to Formula (I), condensate to form dimeric, trimeric, oligomeric siloxanes or under specific conditions even polysiloxanes. Thus, usually mixtures of such products are obtained during the hydrolyzation reaction.

For the concept of the present invention it is important that organosilanes selected from the group consisting of compounds according to Formula (I) as well as dimeric, trimeric, oligomeric siloxanes thereof, that comprise at least one free-OH group, are comprised in the coating composition and that condensation of the hydrolyzation products of the organosilanes to polysiloxanes is prevented as far as possible. Hydroxyl groups of the compounds according to Formula (I) can for example react with various forms of hydroxyl groups present in mineral fillers or surfaces or polymers. These groups, thus contribute to the linkage between the hydrophobic fumed silica particles of the composition of the invention and inorganic or organic substrates. As a consequence, the reaction conditions of the hydrolyzation reaction, in particular catalyst and temperature, are preferably selected such, that condensation of the organosilanes of Formula (I) to polysiloxanes is suppressed as far as possible. Further details are described in section “Component (B) Hydrolyzed Organosilane Composition” below.

Preferably the content of the hydrophobically modified fumed silica, based on the total weight of the composition, is not less than 0.1 wt. %, preferably is of from 0.1 to 30 wt. %. more preferred of from 0.15 wt. % to 28.5 wt. %, even more preferred of from 0.15 wt. % to 25 wt. % further preferred of from 0.15 to 15 wt. %, particular preferred of from 0.2 to 10 wt. %, especially preferred of from 0.2 to 7.5 wt. % and most preferred of from 0.25 to 5 wt. %. The amount of hydrophobically modified silica has an impact on the degree of hydrophobicity, preferably super hydrophobicity, of the treated surface. Super hydrophobicity means that water droplets on the coated surface have a contact angle of more than 140°. Thus, water can run off the surface in form of a “ball”, while in less hydrophobic surfaces the contact angle is smaller, water sticks more to the surface and form “semi-ball spheres”.

The desired degree of durability of the present invention can be set by choosing the ratio of the hydrolyzed organosilane composition of component (B) and the hydrophobically modified fumed silica in component (A). If the amount of hydrolyzed organosilane is reduced the linkage gets weaker. If too much of it is used the surface might look oily and drying becomes difficult. This might even weaken the super-hydrophobic effect. Thus, preferably the ratio of the component (B), in sum of all individual components thereof, to the hydrophobically modified fumed silica in component (A) is in the range of 0.019:1 to 20.92:1, i.e. from (0.019 to 20.92): 1, for example any ranges of from (0.02, 0.03, 0.04, 0.05, 0.06, 0.07, 0.08, 0.09, or 0.10 to 20, 19, 18, 17, 16, 15, 14, 13, 12, 11, 10, 9, 8, 7, 6, 5 or 4): 1, preferably from 0.05:1 to 6.00:1, more preferred from 0.07:1 to 6.00:1 and most preferred of from 0.08:1 to 4.15:1, in terms of weight %.

A solvent or solvent mixture is added in an amount to obtain the desired weight of the composition, i.e. to result in 100 wt. % of the overall composition. The amount can vary if further components beside of (A) and (B) are comprised. Preferably, however, the amount of solvent or solvent mixture is from 30 wt. % to 99.89 wt. %, more preferred from 50 wt. % to 99.845 wt. %, even more preferred 60 to 99.75 wt. %, especially preferred 70 wt. % to 99.8 wt. %, particular preferred 80 wt. % to 99.7 wt. % and most preferred 90 wt. % to 99.5 wt. % based on the total weight of the whole composition.

### Component (A) Hydrophobic Fumed Silica Particles

The silica particles used as component (A) in the composition of the invention are hydrophobically modified fumed silica particles.

“Fumed silica” are also called “pyrogenic silica” are silica obtained by flame hydrolysis. Their properties differ from silica obtained by wet manufacturing processes like for example “precipitated silica” and “silica gels”. Precipitated silicas are obtained by reaction of an alkaline silicate solution with a mineral acid. Silica gels may be obtained by the sol-gel process, i.e. a reaction of tetraalkoxysilanes with water. The different types of silica are known in the art and commercially available in different grades.

Hydrophobically modified means that fumed silica particles were reacted with at least one hydrophobizing material and thus, contain carbon containing residues of groups on their surface. Hydrophobization of silica particles is a well-known process in the art. Such silicas are commercially available. Hydrophobically modified fumed silica particles that may be used in the present invention include silica particles that have been hydrophobized by any means known in the art.

In some embodiments of the invention, the silicon dioxide utilized is a colloidal silicon dioxide. Colloidal silicon dioxide is a generally fumed silica prepared by a suitable process to reduce the particle size and modify the surface properties.

A common process in the art to modify the surface properties of silica particles is to produce fumed silica, for example by production of the silica material under conditions of a vapor-phase hydrolysis at an elevated temperature with a surface modifying silicon compound, such as silicon dimethyl dichloride. Such products are commercially available from a number of sources, including Cabot Corporation, Tuscola, Ill. (under the trade name CAB-O-SIL) and Evonik Indutsries AG (under the trade name AEROSIL).

Suitable hydrophobically modified fumed silica particles include, but are not limited to those commercially available from Evonik Industries AG; as designated under the R Series of the AEROSIL® and AEROXIDE®LE trade names. The different AEROSIL®R and AEROXIDE®LE types differ in the kind of hydrophobic coating, the BET surface area, the average primary particle size and the carbon content. The hydrophobic properties are a result of a suitable hydrophobizing treatment, e.g., treatment with at least one compound from the group of the organosilanes, alkylsilanes, the fluorinated silanes, and/or the disilazanes. Commercially available examples include AEROSIL®R 202, AEROSIL®R 805, AEROSIL® R 812, AEROSIL®R 812 S, AEROSIL® R 972, AEROSIL®R 974, AEROSIL®R 8200, AEROXIDE®LE-1 and AEROXIDE® LE-2.

Other fumed silica materials are also suitable when hydrophobically modified by use of hydrophobizing materials capable of rendering the surfaces of the fumed silica particles suitably hydrophobic. The suitable hydrophobizing materials include all those common in the art that are compatible for use with the silica materials to render their surfaces suitably hydrophobic. Suitable examples, include, but are not limited to: the organosilanes, alkylsilanes, the fluorinated silanes, and/or the disilazanes. Suitable organosilanes include, but are not limited to: alkylchlorosilanes; alkoxysilanes, e.g., methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, butyltrimethoxysilane, butyltriethoxysilane, hexyltrimethoxysilane, octyltrimethoxysilane, 3-mercaptopropyltrimethoxysilane, n-octyltriethoxysilane, phenyltriethoxysilane, polytriethoxysilane; trialkoxyarylsilanes; isooctyltrimethoxy-silane; N-(3-triethoxysilylpropyl) methoxyethoxyethoxy ethyl carbamate; N-(3-triethoxysilylpropyl) methoxyethoxyethoxyethyl carbamate; polydialkylsiloxanes including, e.g., polydimethylsiloxane; arylsilanes including, e.g., substituted and unsubstituted arylsilanes; alkylsilanes including, e.g., substituted and unsubstituted alkyl silanes including, e. g., methoxy and hydroxy substituted alkyl silanes; and combinations thereof. Some suitable alkylchlorosilanes include, for example, methyltrichlorosilane, dimethyldichlorosilane, trimethylchlorosilane, octylmethyldichlorosilane, octyltrichlorosilane, octadecylmethyldichlorosilane and octadecyltrichlorosilane. Other suitable materials include, for example, methylmethoxysilanes such as methyltrimethoxysilane, dimethyldimethoxysilane and trimethylmethoxysilane; methylethoxysilanes such as methyltriethoxysilane, dimethyldiethoxysilane and trimethylethoxysilane; methylacetoxysilanes such as methyltriacetoxysilane, dimethyldiacetoxysilane and trimethylacetoxysilane; vinylsilanes such as vinyltrichlorosilane, vinylmethyldichlorosilane, vinyldimethylchlorosilane, vinyltrimethoxysilane, vinylmethyldimethoxysilane, vinyldimethylmethoxysilane, vinyltriethoxysilane, vinylmethyldiethoxysilane and vinyldimethylethoxysilane.

Disilazanes, which can be employed in the present invention as processing aid, are well known in the art. Suitable disilazanes include for example, but are not limited to: hexamethyldisilazane, divinyltetramethyldisilazane and bis(3,3-trifluoropropyl)tetramethyldisilazane. Cyclosilazanes are also suitable, and include, for example, octamethylcyclotetrasilazane. Thus, these disilazanes and cyclosilazanes can be used as either or both as hydrophobizing material for hydrophobically modifying fumed silica particles and as a processing aid in forming the pre-dispersion explained below.

Suitable fluorinated silanes include the fluorinated alkyl-, alkoxy-, aryl- and/or alkylaryl-silanes, and fully perfluorinated alkyl-, alkoxy-, aryl- and/or alkylaryl-silanes. Examples of fluoroalkyl silanes include, but are not limited to: those marketed by Evonik Industries AG under the trade name of Dynasylan. An example of a suitable fluorinated alkoxy-silane is perfluorooctyl trimethoxysilane.

The hydrophobically modified fumed silica particles used as component (A) of the present invention preferably have a median particle size in the range of from 100 to 50,000 nm, more preferably of from 100 to 42,000 nm, even more preferably of from 100 and 4,000 nm, especially preferred of from 100 to 3,000 nm, and most preferred of from 100 to 1,000 nm. Further preferred median particle sizes of the fumed silica particles are of from 150 to 100,000 nm, of from 150 to 50,000 nm, of from 150 to 42,000 nm, of from 150 to 4,000 nm, of from 150 to 3,000 nm, of from 150 to 1,000 nm, of from 200 to 50,000 nm, of from 200 to 42,000 nm, of from 200 to 4,000 nm, of from 200 to 3,000 nm, of from 200 to 1,000 nm. The median particle size can be used to set the desired degree of transparency for the applied coating composition. Smaller particles, preferably with a median diameter below or equal to 4,000 nm, more preferred below or equal to 3,000 nm, even more preferred below or equal to 2,000 nm and most preferred below or equal to 1,000 nm, enable to produce transparent coatings for examples for treatment of windows or mirrors. With larger particles less-transparent or even totally white coating can be obtained. Such coatings may for example be of interest for fabric, ceramic tile, or wood surface.

The hydrophobically modified fumed silica component (A) is further very important for the composition of the invention to offer super-hydrophobicity or water repelling effect.

### Component (B) Hydrolyzed Organosilane Composition

As described before the hydrolyzed organosilane component (B) is important to improve durability of the water repellent performance of the compositions of the present invention. Thus, the coating compositions of the present invention comprise one or more compounds according to Formula (I), wherein Formula (I) is as follows:

X—R—Si(OH)ₘY¹ₙY²ₒ Formula (I)

and/or
dimeric compounds of Formula (I), trimeric compounds of Formula (I), and oligomeric compounds formed by self-condensation reaction of up to 8 preferably up to 7, 6, 5 or 4 molecules according to Formula (I), provided that the compound has at least one or two free —OH groups.

It is preferred that in the composition of the invention the content of compounds as mentioned before in sum is higher than the content of polysiloxanes formed from compounds according to Formula (I).

the organosilanes according to Formula (I) comprise at least on non-hydrolyzable organic moiety —R—X, wherein
X represents a non-hydrolyzable organic residue, preferably a linear, branched or non-branched aliphatic alkyl residue with 1 to 12, preferably with 1 to 6 carbon atoms, optionally substituted with fluorine or chlorine atoms, preferably with fluorine atoms, or represents a functional group selected from the group consisting of amino, epoxy, vinyl, methacrylate, sulfur groups,
R represents a spacer, which can be either an aryl or alkyl chain, preferably an alkyl (CH₂)_{q} with q=1, 2 or 3; more preferred with q=2 or 3;

In a preferred embodiment, X represents a non-hydrolyzable linear, branched or non-branched aliphatic alkyl residue with 1 to 12, optionally substituted with fluorine atoms.

The organosilane according to Formula (I) may further comprises residues Y¹ and/or Y², which may be identical or different and which may be hydrolyzable or non-hydrolyzable.

If Y¹ and/or Y² are non-hydrolyzable, they are selected from the group consisting of linear, branched or non-branched, alkyl groups with 1 to 12, preferably with 1 to 6 carbon atoms, more preferred methyl, ethyl or propyl, most preferred methyl, or cyclic aliphatic alkyl groups with 1 to 12, preferably 1 to 6 carbon atoms, and aryl groups with 6 to 12 carbon atoms.

If Y¹ and/or Y² are hydrolyzable they are selected from the group consisting of halogen, preferably chlorine, alkoxy groups with 1 to 12, preferably 1 to 6 carbon atoms, more preferred methoxy, ethoxy, isopropoxy and n-propoxy and acyl groups with 1 to 12, preferably 1 to 6 carbon atoms, more preferred formyl, acetyl groups.

In a preferred embodiment the hydrolyzable organosilane component is a hydrolyzable fluoroalkylsilane of the general Formula (III)

CF₃(CF₂)ᵣ(CH₂)₂Si(CH₃)ₛX′₃₋ₛ Formula (III),

in which X′ is a group selected from chlorine, methoxy, ethoxy, isopropoxy, and n-propoxy and r is a number from the series 3, 4, 5, 6, 7, 8, and 9, and s is 0 or 1. Hydrolyzed organosilane compositions (B) of this type are further described in and may be prepared according the processes disclosed in EP 1960481 B1, which is incorporated herein by reference.

Particular preferred CF₃—(CF₂)₅—(CH₂)₂—Si(OCH₃)₃, CF₃—(CF₂)₅—(CH₂)₂—Si(OC₂H₅)₃, CF₃—(CF₂)₅—(CH₂)₂—SiCl₃, CF₃—(CF₂)₅—(CH₂)₂—Si(CH₃)Cl₂, CF₃—(CF₂)₇—(CH₂)₂—SiCl₃, CF₃—(CF₂)₇—(CH₂)₂—Si(OCH₃)₃, CF₃—(CF₂)₇—(CH₂)₂—Si(OC₂H₅)₃, C₁₀F₂₁—(CH₂)₂—Si(OCH₃)₃, C₁₀F₂₁—(CH₂)₂—Si(OC₂H₅)₃, C₁₀F₂₁—(CH₂)₂—SiCl₃ or a mixture thereof are used.

In Formula (I)

m=1, 2 or 3, preferably 2 or 3, more preferred 3,
n, p each may be 0 or 1, but are selected such that m+n+o+p=3.

Preferably the compounds according to Formula (I), more preferred the whole Component (B), is a reaction product of a hydrolyzation of an organosilane according to Formula (II)

X—R—SiY¹Y²Y³ (II)

with water and a catalyst. In Formula (II) X and R are defined as for Formula (I). Y¹, Y² and Y³ are also defined as for Formula (I) but with the proviso that at least one, preferably two, more preferred all three of the residues Y¹, Y² and Y³ must be hydrolysable.

Most preferred hydrolysable organosilanes according to Formula (II), used to form compounds according to Formula (I) respectively component (B), are tridecafluorooctyltriethoxysilane (Dynasylan® F 8261), octyltriethoxysilane (Dynasylan® OCTEO, available from Evonik Industries AG), Dynasylan® SIVO® CLEAR EC (Organosilane according to Formula III, commercially available from Evonik Industries AG) and other similar organosilanes that undergone hydrolysis.

The inventors found out that hydrolyzation under acidic condition rather suppresses self-condensation while use of a base as catalyst rather expedites self-condensation. It is thus, preferred to use an acid as catalyst, more preferred to use HCl or HCl diluted with water.

It is further Preferred that the molar ratio of said hydrolyzable organosilane according to Formula (II) to water during the hydrolyzation reaction is in the range of from 1:4.5 to 1:9, more preferred of from 1:4.8 to 1:7 and most preferred of from 1:5 to 1:6. This molar ratio contributes to definition of the degree of hydrolyzation and thus has an impact on the power of the hydrolyzed organosilanes to form a linkage between the hydrophobically modified fumed silica and surface of the treated substrate after the coating composition is applied.

Residues or reaction products of the hydrolyzation of the organosilane are preferably comprised in the inventive composition, i.e. the reaction mixture of the hydrolyzation is preferably used as is, i.e. without isolation of the hydrolyzed organosilane according to Formula (I). Residues might further include unreacted water or acid. Side products may be separated residues Y¹, Y² and/or Y³.

Since polymerization of the hydrolyzation products of the organosilane is preferably avoided, it is especially preferred that no solid components due to polymerization are comprised in component B) and that component B) is a clear liquid.

### Component (C) Solvent or Solvent Mixture

A solvent is employed in the inventive process and/or compositions in the capacity of a liquid carrier for methods of delivering and effectively applying the compositions to a receptive surface in a manner capable of forming a functional protective coating on the surface. Preferably the solvent used is a volatile solvent, i.e. a solvent that is able to vaporize after application of the coating composition to a surface. In other words the volatile solvent vaporizes under the environmental conditions, temperature, pressure etc., the coated surface is exposed to. A high volatile solvent may therefore be helpful for fast drying.

The volatile solvent is conventional and may selected from:

Volatile silicones, such as hexamethyldisiloxane, octamethyltrisiloxane, decamethylpentacyclo-siloxane, disiloxane, trisiloxane, cyclomethicones such as dimethylcyclosiloxane, hexamethylcyclotrisiloxane (D3), cyclomethicone D4, D5 or D6, and any mixtures thereof; light petroleum; ethanol; isopropanol; gas alkanes like isohexane; and aerosol propellants like propane/isobutene.

Suitable volatile solvents may also be selected from the group of aromatic, branched, cyclic, and/or linear hydrocarbons with 2 to 14 carbon atoms, optionally substituted with fluorine or chlorine atoms, monovalent linear or branched alcohols, aldehydes or ketones with 1 to 6 carbon atoms, ethers or esters with 2 to 8 carbon atoms, linear or cyclic polydimethylsiloxanes with 2 to 10 dimethylsiloxy units, or mixtures thereof. Examples of suitable volatile solvents include, but are not limited to: n-propane, n-butane, n-pentane, cyclo-pentane, n-hexane, cyclo-hexane, n-heptane, isododecane, kerosene, methanol, ethanol, 1-propanol, isopropanol, 1-butanol, dimethylether, diethylether, petroleum ether and ethylacetate, octamethyltrisiloxane, marketed under the trade name Dow Corning 200 Fluid 1 cst, decamethylcyclopentasiloxane, marketed under the trade name Dow Corning 245 (available from Dow Chemical), TEGO® Polish Additiv 5 (available from Evonik Industries AG), perfluorinated solvents, and other halogenated materials such as chlorinated solvents are also suitably employed where their use is appropriate.

Additional solvents that may be employed include those organic solvents having some water solubility and/or water miscibility, and at least some ability to couple with water or moisture that may be present or become incorporated into the inventive compositions through processing, packaging and during application. These are generally added in addition to the more volatile solvent, although they may be employed alone as well as in any suitable combination or mixture capable of stabilizing the dispersion of the hydrophobically modified fumed silica particles during processing, packaging, storage and use.

Suitable organic solvents include, but are not limited to: C₁₋₆ alkanols, C₁₋₆ diols, C₁₋₁₀ alkyl ethers of alkylene glycols, C₃₋₂₄ alkylene glycol ethers, polyalkylene glycols, short chain carboxylic acids, short chain esters, isoparafinic hydrocarbons, mineral spirits, alkylaromatics, terpenes, terpene derivatives, terpenoids, terpenoid derivatives, formaldehyde, and pyrrolidones. Alkanols include, but are not limited to: methanol, ethanol, -n-propanol, isopropanol, butanol, pentanol, and hexanol, and isomers thereof. Diols include, but are not limited to: methylene, ethylene, propylene and butylene glycols. Alkylene glycol ethers include, but are not limited to: ethylene glycol monopropyl ether, ethylene glycol monobutyl ether, ethylene glycol monohexyl ether, diethylene glycol monopropyl ether, diethylene glycol monobutyl ether, diethylene glycol monohexyl ether, propylene glycol methyl ether, propylene glycol ethyl ether, propylene glycol n-propyl ether, propylene glycol monobutyl ether, propylene glycol t-butyl ether, di- or tri-polypropylene glycol methyl or ethyl or propyl or butyl ether, acetate and propionate esters of glycol ethers. Short chain carboxylic acids include, but are not limited to: acetic acid, glycolic acid, lactic acid and propionic acid. Short chain esters include, but are not limited to: glycol acetate, and cyclic or linear volatile methylsiloxanes.

Organic solvents that are less volatile can optionally be included in combination with the more volatile solvent for the purpose of modifying evaporation rates. Suitable examples of less volatile organic solvents are those with lower vapor pressures, for example those having a vapor pressure less than 0.1 mm Hg (20° C.) which include, but are not limited to: dipropylene glycol n-propyl ether, dipropylene glycol t-butyl ether, dipropylene glycol n-butyl ether, tripropylene glycol methyl ether, tripropylene glycol n-butyl ether, diethylene glycol propyl ether, diethylene glycol butyl ether, dipropylene glycol methyl ether acetate, diethylene glycol ethyl ether acetate, and diethylene glycol butyl ether acetate (all available from ARCO Chemical Company).

The volatile organic solvents are preferably selected from the group consisting of linear or branched or cyclic aliphatic, with 2 to 14 carbon atoms, optionally substituted with fluorine or chlorine atoms, or of aromatic hydrocarbons with 6 to 12 carob atoms, optionally substituted with fluorine or chlorine atoms, monovalent linear or branched alcohols with 1 to 6 carbon atoms, ketones or aldehydes with 1 to 6 carbon atoms, ethers or esters with 2 to 8 carbon atoms, or linear or cyclic polydimethylsiloxanes with 2 to 10 dimethylsiloxy units, and mixtures thereof.

It preferred in a special embodiment that the volatile solvent or solvent mixture comprises a linear polydimethylsiloxane with 2 to 10 dimethylsiloxy units. In yet another embodiment, it is preferred that the volatile solvent or solvent mixture within the inventive composition comprises a cyclic polydimethylsiloxane with 3 to 6 dimethylsiloxy units. One highly preferred volatile solvent that is present in the inventive composition is decamethylcyclopentasiloxane.

### Further Components

The composition of the present invention may further comprise as component (D) a compound of general formula (IV) or (V):

(R¹R²R³Si)₂NR⁴ Formula (IV)

—(R¹R²SiNR⁴)ₘ-(cyclo) Formula (V)

wherein R¹, R², and R³ can be the same or different, and are independently selected from hydrogen, linear or branched, saturated or unsaturated alkyl chain groups of from 1 to 8 carbon atoms, or aromatic groups of from 6 to 12 carbon atoms, R⁴ is hydrogen or a methyl group, and m is from 3 to 8.

The components according to Formula (IV) or (V) can be added to keep the process viscosity, in particular of the silica dispersion described below, at a practical level for convenient processing, but to wet and disperse the silica in the solvent more easily. It has further shown that dispersions comprising components according to Formula (IV) or (V) show a retarded settlement of silica particles compared to those without these components.

Component (D) is preferably added together with component (A) in a pre-dispersion as will be explained in more detail further below.

The composition of the invention may be prepared by conventional methods. For example, the composition may be prepared by blending all components while stirring.

The compositions of the present invention may preferably be obtained by a process comprising the steps:
a) Preparation of a silica dispersion, comprising hydrophobically modified fumed silica as defined above and a solvent or solvent mixture as defined above;
b) Preparation of component (B) by hydrolyzation of
   b1) at least one hydrolyzable organosilane according to Formula (II), with
   b2) a catalyst, preferably an acid, most preferred HCl, and
   b3) water;
c) Mixing the silica dispersion from step a) with the composition obtained in step b) and optionally further solvent or solvent mixture.

In step c) the amounts of the silica dispersion a) and of the composition from step b) are selected such that a weight of the hydrolyzed organosilane to the hydrophobically modified fumed silica and that the concentration of the hydrophobically modified fumed silica are as defined for the inventive composition above.

Preferably the silica dispersion in step a) comprises from 60 to 95%, preferably of from 70 to 95%, even more preferably of from 75 to 95% and most preferred 90 to 95%, by weight of a solvent or solvent mixture, based on the overall composition of the silica dispersion.

Further preferred the silica dispersion in step a) comprises 5 to 30 wt. %, more preferred 5 to 25 wt. %, even more preferred 5 to 15 wt. % and most preferred 5 to 10 wt. % of hydrophobically modified fumed silica, based on the overall composition of the silica dispersion.

If compounds of according to Formula (IV) and/or (V) are comprised, their concentration if preferably in the range of from 0.1 to 10 percent by weight of the total weight of the silica dispersion.

The contents of the components comprised in the dispersion are selected from the given ranges and preferred ranges in a manner to result in combination at 100% by weight of the composition.

The solvent or solvent mixture present in the silica dispersion is preferably added during the formation of a pre-dispersion (e.g., a first solvent or solvent mixture) and partly may have been added after formation of the silica dispersion as a diluent (e.g., a second solvent or solvent mixture). It is preferred to use organic solvents or solvent mixtures as defined for component (C) above. The solvent or solvent mixture in steps (a) and (c) may be the same or different.

Suitable equipment for effectively dispersing the hydrophobically modified fumed silica particles include any kind of device which is capable of applying high enough shear forces to a concentrated particulate slurry and thus being effective at decreasing the average particle size distribution of particles within the slurry down to the desired particle size.

The hydrophobically modified fumed silica and silica dispersion a) may be prepared according the processes and equipment disclosed in WO2007051747 or US20040213904A1, which are incorporated herein by reference.

In some preferred embodiments, the silica dispersion of step a) may be prepared according to the process comprising:

suspending hydrophobic particles having an average particle diameter of from 100 to 100,000 nm in a solution of a silicone wax in a highly volatile siloxane, wherein said silicone wax is liquid at room temperature, and said highly volatile siloxane is liquid at room temperature and comprises at least one compound of general Formula (VI), a cyclic compound of general Formula (VII) or a mixture thereof

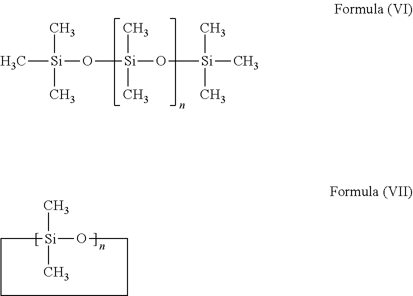

wherein n in Formula (VI) is a number from 2 to 10, preferably n in formula (VII) is from to

In some embodiments, the highly volatile siloxane is a compound of formula (VI) wherein n is from 2 to 5.

In some embodiments, the highly volatile siloxane is a compound of formula (VII) wherein n is from to

In some embodiments, the silicone wax comprises at least one compound of general Formula (VIII):

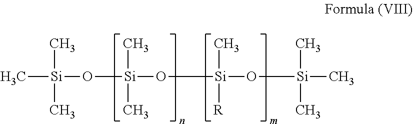

where R is a hydrocarbon radical, n is from 2 to 85, and m is from 2 to 60, the recrystallization points of said compounds of formula (VIII) is below about 20° C.

In some embodiments, the R in formula (VIII) is a hydrocarbon radical having from 10 to 20 carbons atoms.

In some preferred embodiments, the silica dispersion of step a) comprises as additional component 0.01 to 10% by weight of an amine according to Formula (IV) or (V) as defined above.

In this case the silica dispersion in step a) may be prepared according to the process comprising:
(a1) providing a pre-dispersion comprising hydrophobically modified fumed silica particles by stirring said silica particles into a solution comprising:
   (i) at least one compound of general Formula (IV) or (V), wherein R¹, R², R³ and R⁴ are defined as above, and
   (ii) a first solvent or solvent mixture selected from the solvents defined for component (C) above, preferably selected from straight or branched, linear or cyclic aliphatic, or aromatic hydrocarbons with 2 to 14 carbon atoms, optionally substituted with fluorine or chlorine atoms, monovalent linear or branched alcohols with 1 to 6 carbon atoms, ketones or aldehydes with 1 to 6 carbon atoms, ethers or esters with 2 to 8 carbon atoms, or linear or cyclic polydimethylsiloxanes with 2 to 10 dimethylsiloxy units,
   wherein the concentration of the hydrophobically modified fumed silica particles in the pre-dispersion results in from 10 to about 30 percent by weight of the total weight of the pre-dispersion, and wherein the concentration of any one of compounds according to Formula (II) and/or (III) is between 0.1 and 10 percent by weight of the total weight of the pre-dispersion; and
(a2) mixing with a disperser said pre-dispersion to provide a silica dispersion while reducing said silica particles to a median particle size as defined for component (A) above.

Preferably, component (A) is prepared as a silica dispersion. In particular preferred, the component (A) of the coating composition of the present invention is prepared according to the preparation method of silica dispersion described herein.

In some embodiments, the process step a) to prepare silica dispersion may further comprises a dilution step after mixing step wherein a second solvent or solvent mixture, which is the same or different solvent or solvent mixture as the first solvent or solvent mixture, is used as the diluent to provide a final concentration of the hydrophobically modified fumed silica particles.

In step b) the hydrolyzed organosilane composition (B) is obtained from hydrolyzation of a hydrolyzable organosilane according to Formula (II), preferably with water and a catalyst, more preferred with an acid as catalyst, most preferred with HCl as catalyst.

Hydrolyzable organosilanes that can be used are defined for component (B) above, preferred are those according Formulas (II) and (III).

In a preferred embodiment, component (B) is obtainable by subjecting a hydrolyzable organosilane in the presence of an acid, preferably HCl, to partial, i.e., controlled, hydrolysis.

An example of a preferred reaction mixture to obtain component (B) of the invention comprises
b1) 20 parts by weight of at least one hydrolyzable organosilane of Formula (II),
b2) 0.05 to 0.15 part by weight, preferably 0.07 to 0.12 part by weight, more preferably 0.074 to 0.11 part by weight of HCl, and
b3) 3.2 to 6.4 parts by weight of H₂O, preferably 3.6 to 6 parts by weight, more preferably 3.7 to 4.2 parts by weight, in particular 3.8 to 4.0 parts by weight of H₂O.

In a preferred embodiment the process for preparing the composition of component (B) is carried out as follows:

In general the hydrolyzable organosilane is subjected to controlled hydrolysis in the presence of defined amounts of water and a catalyst, preferably an acid, most preferred HCl and optionally an alcohol, the molar ratio of hydrolyzable organosilane to water is being set at 1:4.5 to 1:9. Usually the reaction is carried out advantageously with effective mixing and at a temperature in the range from 0 to 80° C., preferably 10 to 60° C., more preferred 15 to 50° C., even more preferred 20 to 40° C. and most preferred at room temperature, preferably for a time of 1 to 4, more preferred 1 to 3 hours. If the reaction time is too long, the content of condensation and polymer products may increase. Higher reaction temperatures also expedite formation of polymeric products. Thus, it is preferred to keep the reaction temperature as low as possible ensure a good kinetic and a low polymerization rate.

In some embodiments, at the end of the hydrolyzation reaction, an alcohol or volatile solvent may be added to inhibit further self-condensation.

A non-limiting example for a process step b) of the present invention comprises the following steps:
Mixing the hydrolyzable organosilane according to Formula (II) with water and then a catalyst, preferably an acid, most preferred HCl, and
Stirring the mixture thus obtained for 1 to 4 hours, preferably for 2 to 3 hours, at a temperature of 0 to 80° C., preferably of room temperature to 40° C.,
Wherein the molar ratio of hydrolyzable organosilane to water is in a range of 1:4.5 to 1:9.

In a second non-limiting examples for a process step b) of the present invention comprises the following steps:
Adding the at least one hydrolyzable organosilane according to Formula (II) to a mixture of water and a catalyst, preferably an acid, most preferred HCl, and
Stirring the mixture thus obtained for 1 to 4 hours, preferably 2 to 3 hours, at a temperature of 0 to 80° C., preferably of room temperature to 40° C.,
Wherein the molar ratio of hydrolyzable organosilane to water is in a range of 1:4.5 to 1:9.

If an alcohol is added it is preferred to add 500 to 1000 parts by weight of an alcohol, preferably isopropanol.

As acid it is preferred to use an aqueous HCl solution, in particular a 37% strength hydrochloric acid solution. Alternatively the HCl component can be generated under hydrolysis conditions by the corresponding proportional use of a chlorosilane. A further alternative is to supply the HCl to the system in gas form, by introducing it correspondingly into the mixture of components b1) for example.

Water may already be present—at least proportionally—in the acid or else can be used separately or additionally in the form of fully deionized water or distilled water.

The present invention further provides a composition, in particular a coating composition, which is prepared according to the above method to prepare the compositions of the present invention.

The composition of the invention is ready to use and applied in convention methods, for example the application methods described in “Application Means” of WO2007051747, which is incorporated herein by reference.

In some embodiments, the application method may include the following steps,

1) Ensure that the substrate surface is clean and completely dry,
2) Spray the composition onto the substrate surface. The distance from the sprayer nozzle to the substrate surface for an aerosol may be 15-30 cm to provide an even surface distribution.
3) Allow the surface to dry in air completely.

Do not touch or wipe the treated surface neither after spray nor after dry. Otherwise, the coating may be destroyed. If the coating is destroyed, clean the surface and re-apply the treatment. It may take 0.5-5 hours to dry depending on temperature. Hot blowing can speed up the drying process.

The composition may be used to treat surface on substrate with or without hydroxyl groups. The substrate of the surface to be treated being selected from the series glass, wood, glazes, minerals, metal, textiles, cement, ceramic, polycarbonate, polymethyl methacrylate, polyurethane, polystyrene, polymethyl methacrylate and polyethene, especially glass, wood, minerals, metal, cement, and ceramic.

The compositions can produce detachable and renewable dirt- and water-repellent surface coatings on a wide variety of materials and substrates. The surface coatings may be self-cleaning with water.

The compositions are particularly useful in providing nearly invisible detachable coatings and treated articles featuring surface protective benefits including dirt- and water-repellency, self-cleaning with water, and easier cleaning benefits when applied to a variety of automotive and home surfaces, both interior and exterior, including articles and materials such as metals, painted materials, sealed materials, plastics and polymeric articles, wood, textiles and the like.

The present invention further provides an article which comprises at least one surface treated by the composition of the present invention. The surface has properties like long lasting super-water repellent and self-cleaning properties. The article may be household, industrial and institutional, transportation articles including but not limited to vehicles, tents, weather-proof clothing, road signs, sculptures, monuments, wood siding, etc. Said surface may be treated by the application method above. Said surface may be the surface of the substrates mentioned above.

Therefore, the composition may be used in applications including, household applications, industrial and institutional applications, transportation such as vehicles, tents, weather-proof clothing, road signs, sculptures, monuments, wood siding, etc.

After application, the composition of the invention provides super-hydrophobic nano-structured layer (coating) where dust, dirt and water is repelled. The coating may maintain good water-repellency performance for more than 1 month. Furthermore, the coating can sustain during heavy rain, or even high pressure water flush fora while. The composition of the invention is especially applicable for car bumpers, rims, and rear view mirrors which are exposed to weathering conditions.

Other advantages of the present invention would be apparent for a person skilled in the art upon reading the specification.

### BRIEF DESCRIPTION OF DRAWINGS

FIG. 1 shows a photo of a water drop on surface of the product coated with the coating composition of the Example 8.

FIG. 2 shows a photo of water drop on surface of the product after the surface of the coated product was gently wiped by finger.

FIG. 3 shows a photo of the water drop on surface of the product before coating.

### ANALYTIC METHODS

### Median Particle Size

The median particle size was measured using a Horiba LA 910 (use of 1.0 micron polystyrene dispersion as calibration standard, measurement of sample dispersions diluted with isopropyl alcohol and with Relative Refractive Index=1.10). This instrument measures the size and distribution of particles suspended in liquid using laser diffraction.

### Durability Test

Durability test was conducted according the process below:

1) Using a separating funnel to control the generation of droplets in a speed of ≣2 drops/second. The height (from lower end of funnel to mirror surface) is ˜25 cm. Count the drops until the coating is destroyed with visible water adhere on the mirror;
2) Notice to keep the funnel stable throughout the drop-test cycle to make sure that droplets always hit the same sample point of mirror surface; and
3) Once one cycle is finished, change to another area of the mirror and repeat. Take the average of 2-3 cycles as the durability test result.

### Contact Angle Analysis

Contact angle analysis were performed by an electronic water drop angle tester, type MHT-SD2, commercially available from Shenzhen Zhongzheng Instrument Co. Ltd., China.

### EXAMPLES

The invention is now described in detail by the following examples. The scope of the invention should not be limited to the embodiments of the examples.

### Hydrophobically Modified Fumed Silica Dispersion

### Example A(a)

A quantity of 0.5 g of hexamethyldisilazane (DYNASYLAN® HMDS, Evonik Industries AG) was dissolved in 74.5 g of decamethylcyclopentasiloxane (TEGO® Polish Additiv 5, also designated as siloxane “D5”, Evonik Industries AG). 25 g of a commercially available, hydrophobized fumed silica with a BET surface area of 220 m²/g (AEROSIL® R 812 S, Evonik Industries AG) was slowly dispersed in this solution with gentle stirring at 2000 r.p.m. After all fumed silica had been added, the mixing speed of the Dispermat (single rotating shaft, outfitted with saw-tooth blade proportional to mixing vessel where blade is half the diameter of vessel) was increased to 10,000 r.p.m. and kept operating at this speed for 5 min.

### Example A(b)-A(d)

Preparation of example A(b) through A(c) followed the same procedure as for example A(a) except using otherwise specified parameters as shown in Table 1 below. Preparation of example A(d) followed the same procedure as for example A(a) except that hexamethyldisilazane was replaced by 2 wt. % of TEGOPREN® 6814 (Evonik Industries AG), an alkyl-modified polydimethylsiloxane with a molar mass of 13000 g/mol and a recrystallization point of <5° C.

Example A(a) through Example A(c) in Table 1 are representative embodiments of materials prepared in the form of silica dispersion according to the process disclosed in U.S. Pat. Pub. No. 2006/0110541A1.

Example A(d) is an representative example of the silica dispersion obtained by following the process disclosed in U.S. Pat. Pub. No. 2004/0213904A1.

TABLE 1
Silica dispersions prepared according to Examples A(a)-A(d)

| | | | | | | | Particle size |
|---|---|---|---|---|---|---|---|
| | AEROSIL ® | DYNASYLAN ® | | TEGOPREN ® | Stirrer | | distribution |
| Composition | R 812 S | HMDS | D5 | 6814 | speed | Time | (median) |
| example | wt. % | wt. % | wt. % | wt. % | r.p.m. | min. | nanometer |
| A(a) | 25.0 | 0.5 | 74.5 | — | 10,000 | 5 | 283 |
| A(b) | 25.0 | 0.5 | 74.5 | — | 5,000 | 15 | 2,115 |
| A(c) | 10.0 | 0.5 | 89.5 | — | 5,000⁽¹⁾ | 5 | 3,771 |
| A(d) | 5.0 | — | 93.0 | 2.0 | 5,000⁽¹⁾ | 15 | 41,265 |

⁽¹⁾Examples A(c) and A(d) were unable to be processed at 10,000 r.p.m.

Examples A(aa) through A(dd) are examples of compositions obtained by further diluting the compositions in Table 1 with D5.

TABLE 2
Diluted Component A(aa)-A(cc)⁽²⁾

| Component | A(aa)wt. % | A(bb)wt. % | A(cc)wt. % |
|---|---|---|---|
| A(a) | 20.0 | — | — |
| A(b) | — | 20.0 | — |
| A(c) | — | — | 50.0 |
| D5 | 80.0 | 80.0 | 50.0 |

⁽²⁾All diluted compositions had an active silica level of ~5 wt. %.

### Hydrolyzed Organosilane Composition (Component (B))

The reactions indicated below in the examples B(a)-B(e) were each carried out in a heatable and coolable reaction apparatus with stirrer, metering means, condenser, water bath, and thermometer.

### Example B(01)

A 100 ml glass stirring apparatus with metering means, reflux condenser, and water bath was charged with 20 g of Dynasylan® F 8261 (tridecafluoro-1,1,2,2-tetrahydrooctyltriethoxysilane, Evonik Industries AG), 4 g of deionized water, and 0.2 g of hydrochloric acid (37% HCl). The molar silane:water ratio was 1:5.8. Immediately after the addition of the hydrochloric acid the temperature rose within 5 minutes from room temperature to 30° C. The batch (i.e. reaction mixture) was subsequently stirred at 26° C. for 3 hours, and the final product was the ready-to-use Component B(01).

### Example B(a) and B(b)

A 100 ml glass stirring apparatus with metering means, reflux condenser, and water bath was charged with 20 g of Dynasylan® F 8261 (tridecafluoro-1,1,2,2-tetrahydrooctyltriethoxysilane, Evonik Industries AG), 4 g of deionized water, and 0.2 g of hydrochloric acid (37% HCl). The molar silane:water ratio was 1:5.8. Immediately after the addition of the hydrochloric acid the temperature rose within 5 minutes to 30° C. The batch was subsequently stirred at 26° C. for 3 hours. It was then diluted with 975.8 g of D5 or isopropanol (“IPA”) in a 2 L glass bottle to give the ready-to-use Component B(a) and Component B(b) respectively.

### Example B(c) and B(d)

A 100 ml glass stirring apparatus with metering means, reflux condenser, and water bath was charged with 20 g of Dynasylan® F 8261 (tridecafluoro-1,1,2,2-tetrahydrooctyltriethoxysilane, Evonik Industries AG), 26 g of isopropanol, 4 g of deionized water, and 0.2 g of hydrochloric acid (37% HCl). The molar silane:water ratio was 1:5.8. Immediately after the addition of the hydrochloric acid the temperature rose within 5 minutes to 30° C. The batch was subsequently stirred at 26° C. for 3 hours. It was then diluted with 950 g of D5 or isopropanol in a 2 L glass bottle to give the ready-to-use Component B(c) and Component B(d) respectively.

### Example B(02)

A 100 ml glass stirring apparatus with metering means, reflux condenser, and water bath was charged with 20 g of octyltriethoxysilane (Dynasylan® OCTEO, Evonik Industries AG), 22.4 g of isopropanol, 7.4 g of deionized water, and 0.2 g of hydrochloric acid (37% HCl). The molar silane:water ratio was 1:5.8. Immediately after the addition of the hydrochloric acid the temperature rose within 5 minutes to 30° C. The batch was subsequently stirred at 26° C. for 3 hours, and the final product was the ready-to-use Component B(02).

### Example B(e)

A 100 ml glass stirring apparatus with metering means, reflux condenser, and water bath was charged with 20 g of octyltriethoxysilane (Dynasylan® OCTEO, Evonik Industries AG), 22.4 g of isopropanol, 7.4 g of deionized water, and 0.2 g of hydrochloric acid (37% HCl). The molar silane:water ratio was 1:5.8. Immediately after the addition of the hydrochloric acid the temperature rose within 5 minutes to 30° C. The batch was subsequently stirred at 26° C. for 3 hours. It was then diluted with 950 g of isopropanol in a 2 L glass bottle to give the ready-to-use Component B(e).

In TABLE 3, the Examples Component B (a)-B(d) comprised around 1.67 wt. % of hydrolyzed tridecafluoro-1,1,2,2-tetrahydrooctyltriethoxysilane, Component B(e) comprised around 1.39 wt. % of hydrolyzed octyltriethoxysilane.

TABLE 3
Component B(a)-B(e)

| Examples of | Ingredients for silane hydrolysis reaction | | | | | | | Diluent after | |
|---|---|---|---|---|---|---|---|---|---|
| Component B | F 8261* | OCTEO** | DI water | | 37% HCl | IPA | | reaction | |
| B (01) | 20 g | — | 4 | g | 0.2 g | — | | — | |
| B (a) | 20 g | — | 4 | g | 0.2 g | — | | 975.8 | g D5 |
| B (b) | 20 g | — | 4 | g | 0.2 g | — | | 975.8 | g IPA |
| B (c) | 20 g | — | 4 | g | 0.2 g | 26 | g | 949.8 | g D5 |
| B (d) | 20 g | — | 4 | g | 0.2 g | 26 | g | 949.8 | g IPA |
| B (02) | — | 20 g | 7.4 | g | 0.2 g | 22.4 | g | — | |
| B (e) | — | 20 g | 7.4 | g | 0.2 g | 22.4 | g | 950 | g IPA |

*F 8261 represents tridecafluoro-1,1,2,2-tetrahydrooctyltriethoxysilane (Dynasylan ® F 8261),
**OCTEO represents octyltriethoxysilane.

### Comparative Example B(f) and B(g)

To prepare Comparative 8 and Comparative 9 below, Components B(f) and B(g) were prepared by hydrolyzation of the organosilane according to Formula (II) with water under a basic catalyst. The preparation of Components B(f) and B(g) were the same as Components B(c) and B(d), respectively, excepted that 37% HCl in Components B(c) and B(d) was replaced by 37% NaOH in Components B(f) and B(g). See Table 4 for details of the preparation conditions.

For both Components B(f) and B(g), lots of insoluble white aggregate could be observed in the hydrolyzed product after the base-catalyzed hydrolysis of silane. This can be explained by the fact that at alkaline pH condition, the hydrolyzed product of silane hydrolysis reaction would typically self-condensate to high molecular weight species—the insoluble white aggregates. The insoluble aggregate, i.e., the self-condensation product does not contribute to the coating durability improvement.

TABLE 4
Component B(f) and B(g)

| Comparative | | | | | | |
|---|---|---|---|---|---|---|
| Examples of | Ingredients for silane hydrolysis reaction | | | | | |
| Component B | F8261 | DI water | 37% NaOH | IPA | Diluent after reaction | |
| B (f)*** | 20 g | 4 g | 0.2 g | 26 g | 949.8 | g D5 |
| B (g)**** | 20 g | 4 g | 0.2 g | 26 g | 949.8 | g IPA |

***B (f) appears hazy and some white aggregates generated
****B (g) bigger white aggregates generated compared to B (f)

### Final Inventive Composition

### Preparation Method of the Composition of the Invention

The composition of the invention was prepared according to the following process:

Blend components A and B with stirring. If component C was present, add component C to a container first then followed by components A and B. The product was a homogeneous, slightly white turbid liquid.

The compositions of the inventive examples 1-16 and comparative examples 1-7 were applied to a smooth glass surface.

### Application Method of the Composition of the Invention

The composition of the invention was applied to a substrate surface according to the method as follows,

1) Ensure that the glass surface is clean and completely dry,
2) Spray the composition onto the glass surface, spray distance from the sprayer nozzle to the glass surface should be ˜25 cm to provide an even surface distribution. For a 10 cm*13 cm mirror surface, normally 4-6 sprays will ensure complete coverage of the liquid on the mirror, and
3) The surface layer should be allowed to dry completely.

Durability tests of the compositions of the inventive examples and comparative examples were done according to the method described above.

The results of the durability tests are shown in Tables 5-8.

TABLE 5
Inventive Composition 1-5 and the corresponding durability
results comparing to Comparative examples 1-4

| | | | | Durability |
|---|---|---|---|---|
| Example No. | Component A | Component B | D5 | (drops) |
| Comparative 1 | 15% A(aa) | — | 85% | 1-2 |
| Comparative 2 | 15% A(aa) | 0.1% F 8261 | 84.9% | 8-10 |
| 1 | 15% A(aa) | 5% B(a) | 80% | 20-25 |
| 2 | 15% A(aa) | 5% B(c) | 80% | 35-40 |
| 3 | 15% A(aa) | 5% B(d) | 80% | >200 |
| Comparative 3 | 15% A(aa) | 0.1% OCTEO | 84.9% | 1 |
| 4 | 15% A(aa) | 5% B(e) | 80% | 80-85 |
| Comparative 4 | 10% A(d) | — | 90% | <10 |
| 5 | 10% A(d) | 5% B(c) | 85% | 100-105 |

As shown in TABLE 5, the Inventive Composition 1-5 had surprisingly much better durability than Comparative examples 1-4.

TABLE 6
Inventive Compositions 4, 6-13 and the corresponding durability
results comparing to Comparative examples 5-6

| | | | | | wt % |
|---|---|---|---|---|---|
| | | | | Durability | ratio(organosilanol:active |
| No. | Component A | Component B | D5 | (drops) | silica) |
| Comparative 5 | 100% A(aa) | — | — | 15-20 | — |
| 6 | 85% A(aa) | 15% B(a) | — | 40-45 | 0.0590:1 |
| 7 | 80% A(aa) | 20% B(a) | — | >140 | 0.0839:1 |
| 8 | 75% A(aa) | 25% B(a) | — | >200 | 0.1118:1 |
| 9 | 95% A(aa) | 5% B(01) | — | >200 | 0.7295:1 |
| 10 | 5% A(aa) | 1.5% B(01) | 93.5% | >200 | 4.1417:1 |
| Comparative 6 | 15% A(aa) | — | 85% | 1-2 | — |
| 11 | 15% A(aa) | 1.4% B(e) | 83.6% | 8-12 | 0.0259:1 |
| 12 | 15% A(aa) | 2% B(e) | 83% | 12-15 | 0.0371:1 |
| 4 | 15% A(aa) | 5% B(e) | 80% | 80-85 | 0.0930:1 |
| 13 | 5% A(aa) | 0.589% B(02) | 94.411% | >200 | 0.6556:1 |

TABLE 7
Inventive Composition 14-16 and the corresponding durability
results comparing to Comparative example 7

| | | | | | wt % | Active |
|---|---|---|---|---|---|---|
| | | | | Durability | ratio(organosilanol:active | silica |
| No. | Component A | Component B | D5 | (drops) | silica) | wt. % |
| Comparative 7 | 15% A(aa) | — | 85% | 1-2 | — | 0.75% |
| 14 | 5% A(aa) | 1.67% B(d) | 93.33% | 25-30 | 0.1116:1 | 0.25% |
| 15 | 3% A(aa) | 1% B(d) | 96% | 10-15 | 0.1113:1 | 0.15% |
| 16 | 3% A(aa) | 0.158% B(01) | 96.842% | 30-33 | 0.7271:1 | 0.15% |

As shown in Tables 6 and 7, the Inventive Composition 4, 6-16 had surprisingly much better durability than Comparative examples 5-7.

TABLE 8
Durability test results of Comparative
example 8 and Comparative example 9

| | | | | Durability |
|---|---|---|---|---|
| Example No. | Component A | Component B | D5 | (drops) |
| Comparative 1 | 15% A(aa) | — | 85% | 1-2 |
| 2 | 15% A(aa) | 5% B(c) | 80% | 35-40 |
| 3 | 15% A(aa) | 5% B(d) | 80% | >200 |
| Comparative 8 | 15% A(aa) | 5% B(f) | 80% | 3 |
| Comparative 9 | 10% A(d) | 5% B(g) | 80% | <4 |

As shown in Table 8, when the hydrolyzation of the organosilane according to Formula (II) with water was performed under a basic catalyst, the prepared coating compositions had no durability improvement and thus were not within the scope of the present invention.

### Example 20: Contact Angle Analysis

The contact angle of pure water on the mirror treated by Inventive Compositions were tested by an electronic water drop angle tester.

The contact angle of pure water on the mirror treated by Inventive Composition 3 was ˜152°.

The other Inventive Compositions also showed a contact angle above 140°.

Thus, the contact angle of pure water on the surface treated by Inventive Compositions was very high.

### Example 21: Water Drops on Different Surfaces

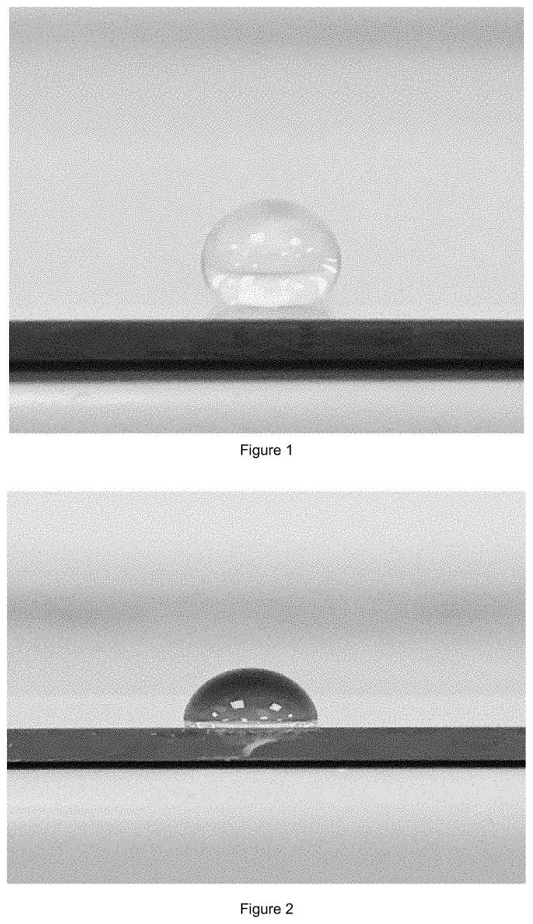

FIGS. 1-3 shows the appearance of water drops on different surfaces. The tests were performed according to the following procedure:

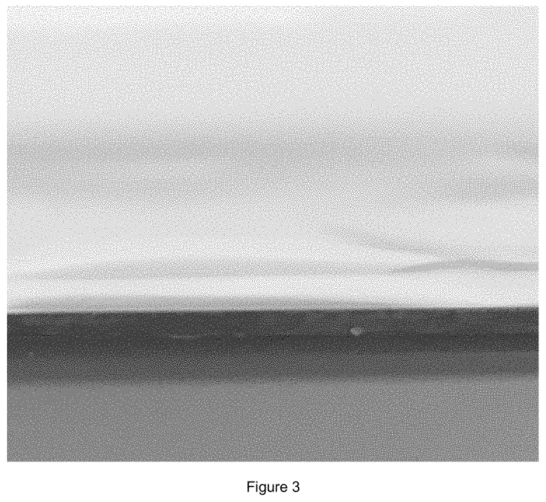

FIG. 3:

1) Ensure that a substrate (glass) surface is clean and completely dry,
2) Drop pure water dropwise onto the glass surface before coated with the composition of Example 8, and
3) Take a photo of the glass surface with water,

### FIG. 1:

1) Ensure that the glass surface is clean and completely dry,
2) Spray the composition of Example 8 onto the glass surface. The distance from the sprayer nozzle to the substrate surface for an aerosol was −20 cm to provide an even surface distribution, allow the surface to dry in air completely,
3) Drop pure water dropwise onto the coated glass surface, and
4) Take a photo of the glass surface with water.

### FIG. 2:

1) Ensure that the glass surface is clean and completely dry,
2) Spray the composition of Example 8 onto the glass surface. The distance from the sprayer nozzle to the substrate surface for an aerosol was −20 cm to provide an even surface distribution, allow the surface to dry in air completely,
3) Wipe the coated glass surface gently by a finger,
4) Drop pure water dropwise onto the coated glass surface gently wiped by finger, and
5) Take a photo of the glass surface with water.

As shown in FIG. 3, the uncoated glass surface was hydrophilic and was immersed by water. After the glass surface was coated by the composition of Example 8, as shown in FIG. 1, the glass surface was super-hydrophobic, and the shape of water drop was nearly spherical. After the coated glass surface was gently wiped by finger, as shown in FIG. 2, the shape of water drop was nearly flat but cannot spread out (much smaller contact angle), this suggested that there was a layer of silica particles on the top of the coated surface and the silica particles were wiped out by finger. After wiped by finger, the surface was still hydrophobic but the hydrophobicity was substantially reduced, and only the hydrolyzed silane played a role of water repellency.

### Comparative Example 10

A glass surface was coated using:

### Component (B) and

a silica dispersion comprising Component (A) and a solvent,
one by one, with the following procedure:
a) Spray Component (B) prepared in Example B(d) onto a glass surface and let it form a coating layer by drying first, then
b) Spay the silica dispersion prepared in Comparative example 1 onto the Component (B) coating layer.

It could be observed that it was difficult for Component (A) to wet the surface and Component (A) shrank to form droplets. Thus, Component (A) could not form a homogeneous coating on the surface pretreated by Component (B). The coating composition of the invention comprising the Component (B) and Component (A) could not be formed. This indicated that the coating composition of the invention comprising the Component (B) and Component (A) as a whole was important to show good performances like super-hydrophobicity.

1-16. (canceled)

17. A composition comprising the following components:
a) hydrophobically modified fumed silica particles with a median particle size of from 100 to 100,000 nm;
b) one or more organosilanol compounds selected from the group consisting of:
compounds of Formula (I), wherein Formula (I) is:
X—R—Si(OH)ₘY¹ₙY²ₒ (I)
wherein:
X is a non-hydrolyzable linear, branched or unbranched aliphatic alkyl residue with 1 to 12 carbon atoms, optionally substituted with fluorine or chlorine atoms; or is a functional group selected from the group consisting of: amino, epoxy, vinyl, methacrylate, or sulfur groups;
R is a spacer and is either an aryl or alkyl chain;
Y¹ and Y² are identical or different and each is independently a hydrolysable or non-hydrolyzable moiety selected from the group consisting of: linear, branched or unbranched, alkyl groups with 1 to 12 carbon atoms; aryl groups with 6 to 12 carbon atoms; halogens; alkoxy groups with 1 to 12, carbon atoms; and acyl groups with 1 to 12 carbon atoms; with the provisio that at least one of Y¹ and Y² is hydrolyzable and is selected from the group consisting of: halogens, alkoxy groups with 1 to 12 carbon atoms; and acyl groups with 1 to 12 carbon atoms;
m=1, 2 or 3;
n and o are each 0 or 1, but are selected such that m+n+o=3; and
dimeric compounds of Formula (I); trimeric compounds of Formula (I); and oligomeric compounds formed by a self-condensation reaction of up to 8 molecules according to Formula (I), provided that the compounds have at least one or two free —OH groups;
c) a solvent or mixture of solvents.

18. The composition of claim 17, wherein:
X is a linear, branched or unbranched aliphatic alkyl residue with 1 to 6 carbon atoms, optionally substituted with fluorine or chlorine atoms;
R is (CH₂)q wherein q=2 or 3;
Y¹ and Y² are identical or different and each is a hydrolysable or non-hydrolysable moiety selected from the group consisting of: methyl, ethyl and propyl groups; a cyclic aliphatic alkyl group with 1 to 6 carbon atoms; chlorine, an alkoxy selected from the group consisting of: methoxy, ethoxy, isopropoxy; and formyl or acetyl groups, with the provisio that at least one of Y¹ and Y² is selected from the group consisting of chlorine, methoxy, ethoxy, isopropoxy and n-propoxy; and a formyl or acetyl group;
m=2 or 3.

19. The composition of claim 17, wherein:
X is a linear, branched or unbranched aliphatic alkyl residue with 1 to 6 carbon atoms, optionally substituted with fluorine;
Y¹ and Y² are each independently methyl; a cyclic aliphatic alkyl group with 1 to 6 carbon atoms; chlorine; or a methoxy, ethoxy, or isopropoxy group.

20. The composition of claim 17, wherein component (B) of Formula I, is a reaction product of the hydrolyzation of an organosilane of Formula (II) with water and a catalyst, wherein Formula (II) is:
X—R—SiY¹Y²Y³ (II)
and wherein X and R are defined as in claim 17 and Y¹, Y² and Y³ are identical or different and each is a hydrolysable or non-hydrolyzable moiety, with the proviso that at least one of Y′, Y² and Y³ is hydrolysable.

21. The composition of claim 20, wherein the hydrolyzable organosilane is a hydrolyzable fluoroalkylsilane of the general formula (III):
CF₃(CF₂)ₙ(CH₂)₂Si(CH₃)_{y}X′_{3-y} (III),
in which X′ is a group selected from chlorine, methoxy, ethoxy, isopropoxy, and n-propoxy;
n is a number from the series 3, 4, 5, 6, 7, 8, and 9; and
y is 0 or 1.

22. The composition of claim 20, wherein the hydrolyzable organosilane is selected from the group consisting of: CF₃—(CF₂)₅—(CH₂)₂—Si(OCH₃)₃; CF₃—(CF₂)₅—(CH₂)₂—Si(OC₂H₅)₃; CF₃—(CF₂)₅—(CH₂)₂—SiCl₃; CF₃—(CF₂)₅—(CH₂)₂—Si(CH₃)Cl₂; CF₃—(CF₂)₇—(CH₂)₂—SiCl₃; CF₃—(CF₂)₇—(CH₂)₂—Si(OCH₃)₃; CF₃—(CF₂)₇—(CH₂)₂—Si(OC₂H₅)₃; C₁₀F₂₁—(CH₂)₂—Si(OCH₃)₃; C₁₀F₂₁—(CH₂)₂—Si(OC₂H₅)₃; C₁₀F₂₁—(CH₂)₂—SiCl₃; and mixtures thereof.

23. The composition of claim 17, wherein the amount of solvent or solvent mixture is from 30 wt. % to 99.89 wt. %, based on the total weight of the composition, and/or the solvent or solvent mixture is selected from the group consisting of: linear, branched or cyclic aliphatic hydrocarbons with 2 to 14 carbon atoms, optionally substituted with fluorine or chlorine atoms; aromatic hydrocarbons with 6 to 12 carbon atoms, optionally substituted with fluorine or chlorine atoms; monovalent linear or branched alcohols with 1 to 6 carbon atoms; ketones or aldehydes with 1 to 6 carbon atoms; ethers or esters with 2 to 8 carbon atoms; linear or cyclic polydimethylsiloxanes with 2 to 10 dimethylsiloxy units; and mixtures thereof.

24. The composition of claim 17, wherein the concentration of the hydrophobically modified fumed silica is not less than 0.1 wt. %, based on the total weight of the composition and/or the hydrophobically modified silica particles have a median particle size in the range of from 100 to 50,000 nm.

25. The composition of claim 17, wherein the ratio of component (B), in sum of all individual components thereof, to the hydrophobically modified fumed silica in component (A) is in the range of 0.019:1 to 20.92:1; and/or the content of compounds of component B in claim 17 in sum in the composition, is higher than the content of polysiloxanes formed from compounds according to Formula (I).

26. The composition of claim 17, wherein the composition further comprises component (D), a compound of general formula (IV) or (V):
(R¹R²R³Si)₂NR⁴ (IV)
—(R¹R²SiNR⁴)ₘ-(cyclo) (V)
wherein R¹, R², and R³ can be the same or different, and are independently selected from: hydrogen; linear or branched, saturated or unsaturated alkyl chain groups of from 1 to 8 carbon atoms; and aromatic groups of from 6 to 12 carbon atoms;
R⁴ is hydrogen or a methyl group; and
m is from 3 to 8.

27. A process for the preparation of a composition of claim 17, wherein the process comprises the steps:
a) preparing a silica dispersion comprising hydrophobically modified fumed silica as defined in claim 17 and a solvent or solvent mixture selected from the group consisting of: linear, branched or cyclic aliphatic hydrocarbons with 2 to 14 carbon atoms, optionally substituted with fluorine or chlorine atoms; aromatic hydrocarbons with 6 to 12 carbon atoms, optionally substituted with fluorine or chlorine atoms; monovalent linear or branched alcohols with 1 to 6 carbon atoms; ketones or aldehydes with 1 to 6 carbon atoms; ethers or esters with 2 to 8 carbon atoms; linear or cyclic polydimethylsiloxanes with 2 to 10 dimethylsiloxy units; and mixtures thereof;
b) preparing a hydrolyzed organosilane component (B) by hydrolyzation of:
i) at least one hydrolyzable organosilane according to Formula (II):
X—R—SiY¹Y²Y³ (II)
wherein X, and R, are defined as in claim 17 and Y¹, Y² and Y³ are identical or different and are each a hydrolysable or non-hydrolyzable moiety, with the provisio that at least one of Y¹, Y² and Y³ is hydrolysable.
ii) a catalyst; and
iii) water;
c) mixing the silica dispersion from step a) with the hydrolyzed organosilane composition obtained in step b) and optionally a further solvent or solvent mixture.

28. The process of claim 27, wherein the silica dispersion in step a) comprises from 60 to 95% by weight of a solvent or solvent mixture based on the overall weight of the dispersion; and/or the silica dispersion in step a) comprises 5 to 30 wt. % of hydrophobically modified fumed silica based on the overall composition of the dispersion; and/or the silica dispersion in step a) comprises 0.1 to 10 percent by weight of the total weight of the dispersion of compounds of Formula (II) as defined in claim 20 and/or Formula (III) as defined in claim 21.

29. The process of claim 27, wherein shear forces are applied to the dispersion to adjust the average particle size distribution to a desired particle size.

30. The process of claim 27, wherein step a) comprises:
a1) providing a pre-dispersion comprising hydrophobically modified fumed silica particles by stirring said silica particles into a solution comprising:
i) at least one compound of general Formula (IV) or (V), wherein R¹, R², R³ and R⁴ are defined as above; and
ii) a first solvent or solvent mixture selected from: straight or branched, linear or cyclic aliphatic, or aromatic hydrocarbons with 2 to 14 carbon atoms, optionally substituted with fluorine or chlorine atoms; monovalent linear or branched alcohols with 1 to 6 carbon atoms; ketones or aldehydes with 1 to 6 carbon atoms; ethers or esters with 2 to 8 carbon atoms; or linear or cyclic polydimethylsiloxanes with 2 to 10 dimethylsiloxy units,
wherein the concentration of the hydrophobically modified fumed silica particles in the pre-dispersion is from 10 to about 30 percent by weight of the total weight of the pre-dispersion, and wherein the concentration of any one of compounds according to Formula (IV) and/or (V) is between 0.1 and 10 percent by weight of the total weight of the pre-dispersion; and
a2) mixing said pre-dispersion with a disperser to provide a silica dispersion while reducing said silica particles to a median particle size as defined for component (A) above.

31. The process of claim 27, wherein step b) comprises:
mixing the hydrolyzable organosilane of Formula (II) with water and a catalyst;
stirring the mixture thus obtained for 1 to 4 hours, at a temperature of 0 to 80° C.; and
choosing a molar ratio of hydrolyzable organosilane to water in a range of 1:4.5 to 1:9.

32. The process of claim 27, wherein the solvent or solvent mixture added in step a) and c) are the same.

33. The process of claim 27, wherein the solvent or solvent mixture added in step a) and c) are different.

34. The process of claim 27, wherein the silica dispersion of step a) is prepared according to a process comprising: suspending hydrophobic particles having an average particle diameter of from 100 to 100,000 nm in a solution of a silicone wax in a highly volatile siloxane, wherein said silicone wax is liquid at room temperature and said highly volatile siloxane is liquid at room temperature and comprises at least one compound of general Formula (VI), a cyclic compound of general Formula (VII) or a mixture thereof: 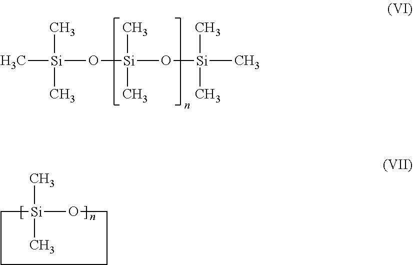
wherein n is a number from 2 to 10.

35. An article which comprises at least one surface treated by the composition of claim 17.
